(19) United States
(12) Patent Application Publication
(10) Pub. No.: US 2011/0198105 A1
(43) Pub. Date: Aug. 18, 2011

(54) NON-HALOGEN FLAME RETARDANT RESIN COMPOSITION AND ELECTRIC WIRE AND CABLE USING THE SAME

(75) Inventors: Daisuke SHANAI, Hitachi (JP); Akinari NAKAYAMA, Hitachinaka (JP)

(73) Assignee: HITACHI CABLE, LTD., Tokyo (JP)

(21) Appl. No.: 12/837,896

(22) Filed: Jul. 16, 2010

(30) Foreign Application Priority Data
Feb. 17, 2010 (JP) 2010-032838

(51) Int. Cl. H01B 7/295; C08L 43/02; C08K 3/26; C08K 3/22

(52) U.S. Cl. 174/110 SR; 524/547; 524/427; 524/430; 524/401

(57) ABSTRACT

An electric wire and cable made of a non-halogen flame retardant resin composition has a modified polyolefin resin composition comprising a polyolefin resin grafted with a phosphate compound having a vinyl group, and an acid acceptor doped to the modified polyolefin resin.

The present application is based on Japanese Patent Application No. 2010-032838 filed on Feb. 17, 2010, the entire contents of which are incorporated herein by reference.

### BACKGROUND OF THE INVENTION

1. Field of the Invention

The present invention relates to environmentally friendly non-halogen flame retardant resin composition and electric wire and cable using the same, which does not contain halogen substance, and harmful heavy metals such as lead, or antimony.

2. Prior Art

As for coating materials for electric wire and cable, polyvinyl chloride (PVC) have been used because the PVC is the most balanced material in terms of flexibility, flame retardant property and cost. In recent years, Pb-free PVC is becoming a mainstream because of the problem of Pb contamination at landfill disposal caused by Pb compounds that have been used as conventional stabilizer. However, even though the Pb-free PVC is used, the Pb-free PVC contains a large amount of chlorine which is one of halogen substances. Therefore, the Pb-free PVC may generate harmful chlorine gas at incineration and even harmful dioxin under certain incineration conditions.

Recently, non-halogen flame retardant resin composition containing no polyvinyl chloride nor halogen-based flame retardant agent is prevailing as coating materials for non-halogen electric wire and cable.

These non-halogen flame retardant resin compositions are made by adding metal hydroxide such as magnesium hydroxide or aluminum hydroxide to soft polyolefin resin such as ethylene-ethyl acrylate, ethylene-vinyl acetate copolymer; ethylene-α-olefin copolymer, or low-density polyethylene. Japanese patent laid-open No. 58-172812 discloses one example of such non-halogen flame retardant resin compositions.

Inorganic metal hydroxide such as magnesium hydroxide is added in large quantity to such a non-halogen flame retardant resin composition so as to provide high flame retardant property. However, there is a disadvantage in that extrusion workability and mechanical property of the resin composition are extremely deteriorated when a large amount of inorganic metal hydroxide is filled. Therefore, a total amount of flame retardant agent to be added is reduced by using combination of red phosphorus and metal hydroxide. Japanese patent laid-open No. 64-74246 discloses one example of such technique.

However, there is a problem that the red phosphorus is partially ionized and dissolved into water when emerged into the water, so that addition of the red phosphorus to the resin results in lowering insulation resistance.

Especially, although various color phases are required to be used in the electric wire and cable, the resin compositions that contain the red phosphorus are colored in red-purple, which limits the color phases. Therefore, the resin compositions containing the red phosphorus are applicable only for limited kinds of electric wire and cable.

### SUMMARY OF THE INVENTION

Accordingly, the object of the present invention is to provide non-halogen flame retardant resin composition and electric wire and cable using the same, which have excellent flame retardant property, colorability, water resistance, and are free from conductor discoloration problem.

According to a feature of the invention, a non-halogen flame retardant resin composition comprises:

a modified polyolefin resin composition comprising a polyolefin resin grafted with a phosphate compound having a vinyl group; and

an acid acceptor doped to the modified polyolefin resin.

The acid acceptor may comprise at least one compound selected from a group consisted of metallic oxide, metallic carbonate, and metallic hydroxide.

The acid acceptor may comprise calcium carbonate.

Additive amount of the acid acceptor is preferably 1 to 250 parts by mass with respect to 100 parts by mass of the modified polyolefin resin composition.

The non-halogen flame retardant resin composition may be used under hygrothermal environment.

According to another feature of the invention, an electric wire comprises:

an insulator comprising a non-halogen flame retardant resin composition comprising:

a modified polyolefin resin composition comprising a polyolefin resin grafted with a phosphate compound having a vinyl group; and

an acid acceptor doped to the modified polyolefin resin.

According to still another feature, a cable comprises:

an insulator or a sheath comprising a non-halogen flame retardant resin composition comprising:

a modified polyolefin resin composition comprising a polyolefin resin grafted with a phosphate compound having a vinyl group; and

an acid acceptor doped to the modified polyolefin resin.

### ADVANTAGES OF THE INVENTION

According to the present invention, it can provide non-halogen flame retardant resin composition and electric wire and cable using the same, which have excellent flame retardant property, colorability, and water resistance, and are free from conductor discoloration problem.

### BRIEF DESCRIPTION OF DRAWINGS

Next, preferred embodiment according to the invention will be explained in conjunction with appended drawings, wherein:

FIG. 1 is a cross sectional view of an electric wire using non-halogen flame retardant resin composition in an embodiment according to the present invention;

FIG. 2 is a cross sectional view of an electric wire (or a cable) using non-halogen flame retardant resin composition in the embodiment according to the present invention; and

FIG. 3 is a cross sectional view of another electric wire (or a cable) using non-halogen flame retardant resin composition in the embodiment according to the present invention.

### DETAILED DESCRIPTION OF THE PREFERRED EMBODIMENT

Next, the preferred embodiment according to the present invention will be explained in more detail in conjunction with the appended drawings.

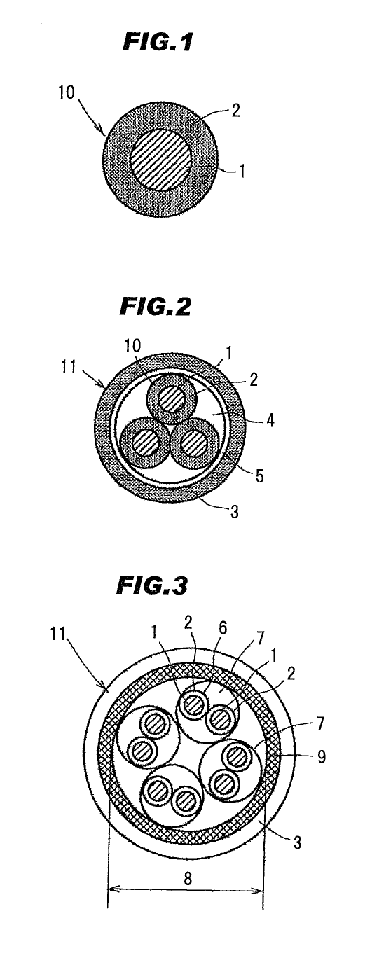

Firstly, examples of electric wire and cable using non-halogen flame retardant resin composition according to the present invention will be explained referring to FIGS. 1 to 3.

### (Total Structure of Electric Wire and Cable)

Referring to FIG. 1, an electric wire 10 comprises a copper conductor 1 coated with an insulator 2, and the insulator 2 is made from a non-halogen flame retardant resin composition of the present invention to be described below.

Referring to FIG. 2, an electric wire (or a cable) 11 comprises three electric wires 10, each of which comprises a conductor 1 coated with an insulator 2. Namely, each of the electric wires 10 is shown in FIG. 1. The three electric wires 10 are stranded together with a filler 4, and wrapped by a tape 5. A sheath 3 is formed as an outermost layer by performing extrusion coating. The insulator 2 and the sheath 3 are made from the non-halogen flame retardant resin composition according to the present invention to be described below.

Referring to FIG. 3, a cable (or an electric wire) 11 comprises a core 8 comprising four stranded wires 7 stranded with each other, each of which comprises two insulated wires 6 stranded with each other. Each of the insulated wires 6 comprises a copper conductor 1 coated with an insulator 2. Namely, each of the insulated wires 6 has a structure similar to each of the electric wires 10 is shown in FIG. 1. In the cable 11, a metal shield 9 is provided around the core 8, and a sheath 3 is provided around the metal shield 9 by extrusion coating. The insulator 2 and the sheath 3 is made from the non-halogen flame retardant resin composition according to the invention to be described below.

### (Non-Halogen Flame Retardant Resin Composition)

The non-halogen flame retardant resin composition composting the insulator 2 and sheath 3 in FIGS. 1 to 3 comprises a modified polyolefin resin composition comprising a polyolefin based resin grafted with a phosphate compound having a vinyl group. Acid acceptor is added to the modified polyolefin resin composition to control discoloration of the copper conductor 1 when used under hygrothermal environment.

In the present application, the “hygrothermal environment” is defined as an environment continuously or intermittently under temperature of 30° C. or more and humidity of 70% or more.

The Inventors of the invention contemplated to provide resin per se with flame-retardant property as non-halogen flame retardant resin composition, instead of adding a large quantity of the flame retardant agent to the resin as in the conventional art, and to apply the non-halogen flame retardant resin thus fabricated to the insulator and/or the sheath.

As to a method for providing the resin with the flame retardant property, the Inventors contemplated that the use of phosphor element having high flame-retardant property may be effective. Then, the Inventors considered grafting a phosphate compound that is transparent and has a vinyl group with the resin.

Also, the Inventors developed non-halogen flame retardant resin composition by using the grafted resin thus fabricated, and researched on its application to the electric wires and cables.

### (Flame Retardant Property and Phosphorus Concentration)

The Flame retardant property of the grafted resin can be improved by increasing an amount of phosphorus contained in the grafted resin, in other words, by increasing a phosphorus concentration per unit mass.

So as to confirm relationship between the flame retardant property and the phosphorus concentration, flame retardant property test was carried out on the electric wires and cables shown in FIGS. 1 to 3 that are made by using the non-halogen flame retardant resin composition. As a result, the relationship between the phosphorus concentration and the flame retardant property was confirmed as follows.

The phosphorus concentration in the grafted resin should be 0.5 mass % or more, in order to pass 60-degree inclined flame test according to JIS C3612.

Even when the phosphorus concentration is less than 0.5 mass %, it is possible to pass the 60-degree inclined flame test by adding an appropriate amount of the flame retardant agent such as melamine cyanurate.

Further, it is confirmed that higher phosphorus concentration was required in order to pass vertical flame test such as vertical tray flame test. More concretely, the phosphorus concentration should be 2.5 mass % or more to pass the vertical flame test.

### (Discoloration and Acid Acceptor)

Further, the Inventors confirmed that discoloration of the copper conductor can be controlled by mixing the acid acceptor into the grafted resin in which the phosphorus compound having the vinyl group is grafted with the polyolefin resin.

It is assumed that the discoloration of the copper conductor may be caused by phosphorus compound released under the hygrothermal environment. Accordingly, it is assumed that the acid acceptor traps the phosphorus compound and controlled the discoloration of the copper conductor. As the acid acceptor, it is preferable to use calcium carbonate which is inexpensive and very effective.

### (Polyolefin Resin)

The polyolefin resin used for the invention includes polyethylene such as low-density polyethylene, linear low-density polyethylene, or linear ultralow density polyethylene, copolymer of ethylene with methyl acrylate, methyl methacrylate, methyl acrylate, vinyl acetate, glycidyl methacrylate, butene-1, propylene, etc., styrene-based elastomer such as SEBS (Styrene Ethylene Butadiene Styrene), SEB (Polystyrene-ethylenebutylene), SIS (polystyrene-isoprene-styrene), SEEPS (hydrogenated poly-isoprene/butadiene), or StEt copolymer (ethylene-styrene copolymer), and maleic acid grafted low-density polyethylene.

When grafting the phosphorus compound having the vinyl group with the polyolefin resin used for the invention, it is more effective to use the phosphorus compound with higher phosphorus content rate per molecule gives. More concretely, it is preferable to use the phosphorus compound having the vinyl group with a phosphorus content rate per molecule of 10 mass % or more.

Namely, the phosphorus content rate per molecule of the phosphorus compound having the vinyl group is preferably 10 mass % or more. More concretely, diethyl vinyl phosphonate, dimethyl vinyl phosphonate, diphenyl vinyl phosphine oxide, and diphenyl vinyl phosphonate shown in following chemical structural formulas 1 to 4 respectively are preferable.

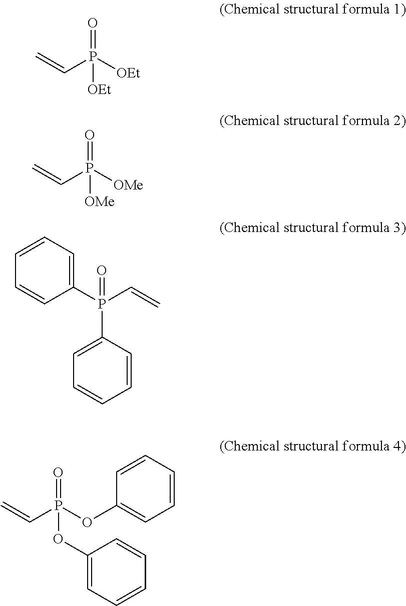

It is necessary to introduce radical(s) into the system where the vinyl phosphorus and the polyolefin coexist, so as to graft the phosphorus compound having the vinyl group with the polyolefin resin. As a method for introducing the radical(s), there are a method of decomposing organic peroxide or azo compound in the system by heat or light, and a method of irradiating electronic beam or γ-ray to the system.

As to the organic peroxide, ketoneperoxides, peroxyketals, hydroperoxides, dialkylperoxides, diacylperoxides, peroxydicarbonates, and peroxyesters may be used.

In the present invention, additive amount of the acid acceptor is 1 to 250 parts by mass with respect to 100 parts by mass of the grafted resin in which the polyolefin resin is grafted with the phosphorus compound having the vinyl group. If the additive amount of the acid acceptor is less than 1 part by mass, the acid acceptor does not work effectively. If the additive amount of the acid acceptor is more than 250 parts by mass, the non-halogen flame retardant resin composition does not provide sufficient mechanical characteristics required for the electric wire and cable. The additive amount of the acid acceptor is more preferably 5 to 200 parts by mass with respect to 100 parts by mass of the grafted resin.

As to the acid acceptor, metallic oxide, metallic carbonate, and metallic hydroxide may be used. Also, these acid acceptors may be used alone or mixed.

As to the metallic oxide, magnesium oxide, calcium oxide, barium oxide, and zinc borate may be used.

As to the metallic hydroxide, magnesium hydroxide, calcium hydroxide, barium hydroxide, zinc hydroxystannate, and hydrotalcite may be used.

As to the metallic carbonate, magnesium carbonate, calcium carbonate, barium carbonate, zinc carbonate dolomite, and huntite may be used.

The aforementioned acid acceptors are all white and have no problem for colorability.

Also, in addition to the aforementioned acid acceptors, antioxidant, lubricant, stabilizer, colorant, process aid, cross-linker, cross-linker aid, copper inhibitor, antistatic, ultraviolet absorber, and light stabilizer may be added as needed.

The non-halogen flame retardant resin composition of the invention may be used not only for the insulator of the electric wire but also for the sheath of the cable.

### Examples

The non-halogen flame retardant resin composition of the invention was fabricated as below.

First, samples of grafted resins # 1 to #5 were prepared according to the compositions shown in TABLE 1.

TABLE 1

| Components | | #1 | #2 | #3 | #4 | #5 |
|---|---|---|---|---|---|---|
| Polymer | EVA (A1) | 100 | 100 | | | |
| | EEA (A2) | | | 100 | 100 | |
| | LDPE (A3) | | | | | 100 |
| Vinyl | Diethyl vinyl | 5 | | 20 | | |
| | phosphonate | | | | | |
| Phosphonate | Dimethyl vinyl | | 5 | | 20 | |
| | phosphonate | | | | | |
| | Polyoxyethylene | | | | | 2 |
| | polyoxypropylene | | | | | |
| | vinyl phosphorate | | | | | |
| Initiator | DCP | 0.2 | 0.2 | 0.8 | 0.8 | 0.1 |
| | (Dicumyl peroxide) | | | | | |
| Analysis Result | Phosphorus element | 0.8 | 0.9 | 3.0 | 3.4 | 0.1 |
| | concentration | | | | | |
| | (mass %) | | | | | |

(A1) EVA (Ethylene-vinyl acetate): “EVAFLEX (trademark) EV460” of Du Pont-Mitsui Polychemicals Co., Ltd.
(A2) EEA (Ethylene-ethyl acrylate): “REXPEARL A1150” of Japan Polyethylene Corporation
(A3) LDPE (Low density polyethylene): “MIRASON 3530” of Prime Polymer Co., Ltd. (and Du Pont-Mitsui Polychemicals Co., Ltd.)

EVA, EEA, and LDPE were used as polyolefin resins which is polymer. With respect to this polymer of 100 parts by mass, Diethyl vinyl phosphonate (phosphorus element content: about 19 mass %), Dimethyl vinyl phosphonate (phosphorus element content: about 23 mass %), or Polyoxyethylene polyoxypropylene vinyl phosphorate (phosphorus element content: about 6 mass %) were prepared in required amount for the target phosphorus concentration as vinyl phosphonate, then dicumyl peroxide (DCP) in appropriate amount was dissolved therein and dipped in the polyolefin resin as the polymer, so that grafted resin was made in extrusion-reaction by an extruder which was set to 180° C.

TABLE 1 shows the compositions and the phosphorus element content measured by fluorescent X-ray analysis (by using RIX2000 of Rigaku Corporation) of the grafted resin.

Samples in Examples 1 to 13 and Comparative examples 1 to 5 were prepared as follows. Respective main compounding agents according to the compositions shown in TABLE 2 are added to the grafted resins #1 to #5 shown in TABLE 1, then kneaded by a pressure kneader at a temperature of 150° C. The kneaded resins are provided around a copper conductor 1 having a diameter of 2.0 mm as the insulator 2 of the electric wire shown in FIGS. 1 to 3 by extrusion coating at 160° C. with a thickness of 0.8 mm.

The electric wire and cable in Examples 1 to 13 and Comparative examples 1 to 5 were evaluated in accordance with following manners.

(1) Tensile Test

Tensile test was conducted on the samples of the electric wire prepared as described above according to JIS C 3005. The target values were tensile strength of 10 MPa or more and elongation of 350% or more.

(2) Inclined Flame Test

The 60-degrees inclined flame test was conducted on the samples of the electric wire prepared as described above according to JIS C 3612. The sample was evaluated as “acceptable (◯)” when the flame self-extinguished within 60 seconds after being burnt for 30 seconds.

(3) Vertical Flame Test

Vertical tray flame test was conducted on the samples of the electric wire prepared as described above according to IEEE383. The sample was evaluated as “acceptable (◯)” when a burnt length is less than 180 cm.

(4) Conductor Discoloration Test

After the sample of the electric wire was heated for 14 days at the temperature of 60° C. and humidity of 95% in a tank of constant temperature and humidity, the coating material was removed to check conductor discoloration by the naked eyes. The sample was evaluated as “acceptable (◯)” when there was no discoloration.

(5) Water Immersion Test

After immersing the sample of the electric wire for 2000 hours in tab water at 75° C., the insulation resistance thereof was measured. The sample of the electric wire was evaluated as “acceptable (O)” when the insulation resistance was 100 MΩ·km or more.

TABLE 2 shows evaluation results of Examples 1 to 13 fabricated by using the non-halogen flame retardant resin compositions according to the present invention, and Comparative examples 1 to 5 fabricated similarly.

TABLE 2

| | | | Examples | | | | | | | | |
|---|---|---|---|---|---|---|---|---|---|---|---|
| | | | 1 | 2 | 3 | 4 | 5 | 6 | 7 | 8 | 9 |
| Material | Grafted Resin #1 | | 100 | 100 | | | | | | | |
| Composition | Grafted Resin #2 | | | | 100 | 100 | | | | | |
| | Grafted Resin #3 | | | | | | 100 | 100 | | | 100 |
| | Grafted Resin #4 | | | | | | | | 100 | 100 | |
| | Grafted Resin #5 | | | | | | | | | | |
| | Calcium Carbonate (B1) | | 1 | 250 | 1 | 250 | 1 | 250 | 1 | 250 | |
| | Magnesium Carbonate (B2) | | | | | | | | | | 5 |
| | Magnesium Hydroxide (B3) | | | | | | | | | | |
| | Hydrotalcite (B4) | | | | | | | | | | |
| | Magnesium Oxide (B5) | | | | | | | | | | |
| | Melamine Cyanurate (B6) | | | | | | | | | | |
| | Antioxidant (B7) | | 0.5 | 0.5 | 0.5 | 0.5 | 0.5 | 0.5 | 0.5 | 0.5 | 0.5 |
| Characteristics | Mechanical | Tensile | 19.2 | 11.1 | 20.1 | 11.6 | 17.2 | 10.8 | 18.4 | 10.9 | 17.1 |
| Evaluation | Characteristics | Strength | | | | | | | | | |
| | | (MPa) | | | | | | | | | |
| | | Stretch (%) | 690 | 420 | 710 | 410 | 670 | 380 | 680 | 400 | 670 |
| | | Judgment | ∘ | ∘ | ∘ | ∘ | ∘ | ∘ | ∘ | ∘ | ∘ |
| | Conductor | Visual | ∘ | ∘ | ∘ | ∘ | ∘ | ∘ | ∘ | ∘ | ∘ |
| | Discoloration | Judgment | | | | | | | | | |
| | Water | Immersion | ∘ | ∘ | ∘ | ∘ | ∘ | ∘ | ∘ | ∘ | ∘ |
| | Resistance | Insulation | | | | | | | | | |
| | | Character | | | | | | | | | |
| | Flame | 60-degrees | ∘ | ∘ | ∘ | ∘ | ∘ | ∘ | ∘ | ∘ | ∘ |
| | retardant | Inclined | | | | | | | | | |
| | property | Flame Test | | | | | | | | | |
| | | Vertical | x | x | x | x | ∘ | ∘ | ∘ | ∘ | ∘ |
| | | Tray Flame | | | | | | | | | |
| | | Test | | | | | | | | | |
| | | | Examples | | | | Comparative Examples | | | | |
| | | | 10 | 11 | 12 | 13 | 1 | 2 | 3 | 4 | 5 |
| Material | Grafted Resin #1 | | | | | | 100 | | | | |
| Composition | Grafted Resin #2 | | | | | | | 100 | | | |
| | Grafted Resin #3 | | 100 | 100 | 100 | | | | 100 | | |
| | Grafted Resin #4 | | | | | | | | | 100 | |
| | Grafted Resin #5 | | | | | 100 | | | | | 100 |
| | Calcium Carbonate (B1) | | | | | 5 | | | | | |
| | Magnesium Carbonate (B2) | | | | | | | | | | |
| | Magnesium Hydroxide (B3) | | 5 | | | | | | | | |
| | Hydrotalcite (B4) | | | 5 | | | | | | | |
| | Magnesium Oxide (B5) | | | | 5 | | | | | | |
| | Melamine Cyanurate (B6) | | | | | 50 | | | | | 50 |
| | Antioxidant (B7) | | 0.5 | 0.5 | 0.5 | 0.5 | 0.5 | 0.5 | 0.5 | 0.5 | 0.5 |
| Characteristics | Mechanical | Tensile | 18 | 16.9 | 17.6 | 12.3 | 19.5 | 20 | 17.5 | 18.6 | 13.9 |
| Evaluation | Characteristics | Strength | | | | | | | | | |
| | | (MPa) | | | | | | | | | |
| | | Stretch (%) | 690 | 670 | 680 | 600 | 700 | 700 | 680 | 680 | 610 |
| | | Judgment | ∘ | ∘ | ∘ | ∘ | ∘ | ∘ | ∘ | ∘ | ∘ |
| | Conductor | Visual | ∘ | ∘ | ∘ | ∘ | x | x | x | x | x |
| | Discoloration | Judgment | | | | | | | | | |
| | Water | Immersion | ∘ | ∘ | ∘ | ∘ | ∘ | ∘ | ∘ | ∘ | ∘ |
| | Resistance | Insulation | | | | | | | | | |
| | | Character | | | | | | | | | |
| | Flame | 60-degrees | ∘ | ∘ | ∘ | ∘ | ∘ | ∘ | ∘ | ∘ | ∘ |
| | retardant | Inclined | | | | | | | | | |
| | property | Flame Test | | | | | | | | | |
| | | Vertical | ∘ | ∘ | ∘ | x | x | x | ∘ | ∘ | x |
| | | Tray Flame | | | | | | | | | |
| | | Test | | | | | | | | | |

(B1) “Vigot-10” of Shiraishi Calcium Kaisha, Ltd.
(B2) “Magnesium Carbonate Gold Star” of Konoshima Chemical Co., Ltd
(B3) “Magsis N4” of Konoshima Chemical Co., Ltd.
(B4) “DHT-4A” (trademark) of Kyowa Chemical Industry Co., Ltd.
(B5) “StarmagL-10” of Konoshima Chemical Co., Ltd
(B6) “STABIACE MC5S” of Sakai Chemical Industry Co., Ltd.
(B7) “Irganox 1010” of Ciba Japan Ltd. (BASF Japan Ltd.)

As shown in TABLE 2, the samples in Examples 1 to 13 are composed of non-halogen flame retardant resin compositions, in which one of calcium carbonate, magnesium carbonate, magnesium hydroxide, hydrotalcite, and magnesium oxide is added as the an acid acceptor to the grafted resins #1 to 5. The samples in Examples 1 to 13 satisfied the target values of mechanical characteristics, water resistance, and flame retardant property, and the conductors thereof did not exhibit discoloration.

More particularly, the phosphorus concentration of each of the samples in Examples 5 to 12 is 2.5 mass % or more, so that the samples in Examples 5 to 12 passed the 60-degrees inclined flame test and the vertical tray flame test. The samples in Examples 5 to 12 were superior in the flame retardant property to the samples in Comparative Examples 1 to 4, and 13 that passed only the 60-degrees inclined flame test, because the phosphorus concentration thereof is less than 2.5 mass %.

On the contrary, the samples in Comparative examples 1 to 4 use the grafted resins #1 to #4, but no acid acceptor is added. Therefore, although the samples in Comparative examples 1 to 4 satisfied the target values of mechanical characteristics, water resistance, and flame retardant property, the conductors thereof exhibited discoloration.

Additionally, although the samples in Example 13 and Comparative example 5 used the grafted resin #5 (phosphorus element concentration of 0.1 mass %) and the phosphorus concentration thereof was less than 0.5 mass %, these samples passed the 60-degrees inclined flame test because melamine cyanurate was added as the acid acceptor. However, no acid acceptor was added to the sample in Comparative example 5, so that the conductor discoloration was confirmed. On the contrary, since the acid acceptor was added to the sample in Example 13, the conductor discoloration was suppressed.

Although the invention has been described with respect to the specific embodiments for complete and clear disclosure, the appended claims are not to be therefore limited but are to be construed as embodying all modifications and alternative constructions that may occur to one skilled in the art which fairly fall within the basic teaching herein set forth.

What is claimed is:

1. A non-halogen flame retardant resin composition, comprising:
a modified polyolefin resin composition comprising a polyolefin resin grafted with a phosphate compound having a vinyl group; and
an acid acceptor doped to the modified polyolefin resin.

2. The non-halogen flame retardant resin composition, according to claim 1, wherein the acid acceptor comprises at least one compound selected from a group consisted of metallic oxide, metallic carbonate, and metallic hydroxide.

3. The non-halogen flame retardant resin composition, according to claim 1, wherein the acid acceptor comprises calcium carbonate.

4. The non-halogen flame retardant resin composition, according to claim 1, wherein additive amount of the acid acceptor is 1 to 250 parts by mass with respect to 100 parts by mass of the modified polyolefin resin composition.

5. The non-halogen flame retardant resin composition, according to claim 1, wherein the non-halogen flame retardant resin composition is used under hygrothermal environment.

6. An electric wire comprising:
an insulator comprising a non-halogen flame retardant resin composition comprising:
a modified polyolefin resin composition comprising a polyolefin resin grafted with a phosphate compound having a vinyl group; and
an acid acceptor doped to the modified polyolefin resin.

7. The electric wire, according to claim 6, wherein the acid acceptor comprises at least one compound selected from a group consisted of metallic oxide, metallic carbonate, and metallic hydroxide.

8. The electric wire, according to claim 6, wherein the acid acceptor comprises calcium carbonate.

9. The electric wire, according to claim 6, wherein additive amount of the acid acceptor is 1 to 250 parts by mass with respect to 100 parts by mass of the modified polyolefin resin composition.

10. The electric wire, according to claim 6, wherein the electric wire is used under hygrothermal environment.

11. A cable comprising:
an insulator or a sheath comprising a non-halogen flame retardant resin composition comprising:
a modified polyolefin resin composition comprising a polyolefin resin grafted with a phosphate compound having a vinyl group; and
an acid acceptor doped to the modified polyolefin resin.

12. The cable, according to claim 11, wherein the acid acceptor comprises at least one compound selected from a group consisted of metallic oxide, metallic carbonate, and metallic hydroxide.

13. The cable, according to claim 11, wherein the acid acceptor comprises calcium carbonate.

14. The cable, according to claim 11, wherein additive amount of the acid acceptor is 1 to 250 parts by mass with respect to 100 parts by mass of the modified polyolefin resin composition.

15. The cable, according to claim 11, wherein the cable is used under hygrothermal environment.
